(19) United States
(12) Patent Application Publication
(10) Pub. No.: US 2008/0112263 A1
(43) Pub. Date: May 15, 2008

(54) SYSTEM AND METHOD FOR DETERMINING SEISMIC EVENT LOCATION

(75) Inventor: Guillaume B. Bergery, Pertuis (FR)

Correspondence Address: CANTOR COLBURN LLP- BAKER ATLAS, 20 Church Street, 22nd Floor, Hartford, CT, 06103, US

(73) Assignee: MAGNITUDE SPAS, Sainte Tulle (FR)

(21) Appl. No.: 11/937,597

(22) Filed: Nov. 9, 2007

Related U.S. Application Data
(60) Provisional application No. 60/865,300, filed on Nov. 10, 2006.

(51) Int. Cl. G01V 1/36

(52) U.S. Cl. 367/50

(57) ABSTRACT

Disclosed is a method for locating a seismic event. The method includes processing seismic data from at least one seismic receiver to validate a potential seismic event, computing a signal travel time between at least one node in an area of interest and the at least one seismic receiver, adjusting the seismic data according to the travel time, and identifying a location of the seismic event based on the adjusted seismic data. Systems for locating a seismic event are also disclosed.

### CROSS REFERENCE TO RELATED APPLICATIONS

Under 35 U.S.C. §119(e), this application claims the benefit of U.S. Provisional Application No. 60/865,300, filed Nov. 10, 2006, the entire disclosure of which is incorporated herein by reference.

### BACKGROUND OF THE INVENTION

1. Field of the Invention

The teachings herein relate to the monitoring of seismic events and, in particular, to the determination of a location for seismic events.

2. Description of the Related Art

Subterranean formations may be monitored using one or more seismic receivers. The receivers may be geophones placed at the surface or submerged in wells or on the ocean floor. Also, the receivers may be hydrophones placed in those same locations, but sensitive to only certain types of waves. The receivers placed in wells may be shallow (usually above the formation of interest) or deep (usually at or below the formation of interest). Seismic receivers may be sensitive to seismic waves along a certain axis or those traveling on any axis. Likewise, the receivers may be sensitive to only certain types of seismic waves, or several types. Those sensitive to certain axis of travel, called directional receivers, may be coupled with other directional receivers. For example, a directional receiver may be coupled with two other directional receivers in a set of three orthogonal receivers which collect information about the waves in three dimensions. This three-dimensional information may be rotated mathematically through the use of trigonometric functions in order to derive information as to wave travel in the x-axis, y-axis, and z-axis relative to gravity. Alternatively, mathematical rotation may provide translation of the data relative to a wellbore, a cardinal direction, or any other reference point.

Microseismic monitoring concerns passively monitoring a formation for seismic events which are very small. Such events may include the seismic effects generated in a formation by fracturing, depletion, flooding, treatment, fault movement, collapse, water breakthrough, compaction or other similar subterranean interventions or effects. One of the main problems with microseismic monitoring, as with other forms of seismic monitoring, is that of noise. With microseismic events, however, the problem is emphasized because the signal strength is generally very small. This means, in turn, that a small amount of noise which would not cause any significant effect as to a regular, active seismic survey causes a significant degradation of the signal to noise ratio in the microseismic survey.

The geology of the microseismic environment is also of interest. Different geological layers are composed of different materials which transmit seismic waves at different velocities. It will be appreciated that when a source occurs in a high-velocity layer, its transmission through to a lower-velocity layer will cause attenuation, as much of the wave energy is reflected back into the high-velocity layer.

Microseismic surveys include receiving data from a receiver, locating data which exceeds some threshold, and analyzing those over-threshold data in order to determine information about certain events. Data which does not meet the threshold is discarded or simply not recorded as noise data.

What are needed are systems and methods for location of microseismic events, such as systems and methods that permit automatic location of those events by a joint analysis of data from a plurality of receivers.

### SUMMARY OF THE INVENTION

Disclosed is a method for locating a seismic event. The method includes processing seismic data from at least one seismic receiver to validate a potential seismic event, computing a signal travel time between at least one node in an area of interest and the at least one seismic receiver, adjusting the seismic data according to the signal travel time, and identifying a location of the seismic event based on the adjusted seismic data.

Also disclosed is a system for locating a seismic event. The system includes a collector providing seismic data from a plurality of seismic receivers to a processor for processing the data signals. Processing includes processing the seismic data to validate a potential seismic event, adjusting the seismic data from at least one of the plurality of seismic receivers according to a signal travel time between at least one node in an area of interest and the at least one of the plurality of seismic receivers, and identifying a location of a seismic event based on the adjusted seismic data.

Further disclosed is a system for locating a seismic event. The system includes a collector for receiving seismic data from a plurality of seismic receivers and providing the seismic data to a processor. The processor implements a method including processing the seismic data to validate a potential seismic event, defining an area of interest, defining at least one node in the area of interest, computing a signal travel time between the at least one node and at least one of the plurality of seismic receivers, adjusting the seismic data for the at least one node according to the travel time, and identifying a location of the seismic event based on the adjusted seismic data.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of a seismic network;

FIG. 2 illustrates an embodiment of a collection machine;

FIG. 3 is a flowchart illustrating exemplary aspects of a method of monitoring seismic events;

FIG. 4 depicts an exemplary interface for automated display of location information; and

FIG. 5 depicts an exemplary field map for automated display of location information.

### DETAILED DESCRIPTION OF THE INVENTION

Subterranean formations are of interest for a variety of reasons. Such formations may be used for the production of hydrocarbons, the storage of hydrocarbons or other substances, mining operations or a variety of other uses. One method used to obtain information regarding subterranean formations is to use acoustic or seismic waves to interrogate the formation. Seismic waves may be generated into the formation and the resulting reflected waves received and analyzed in order to provide information about the geology of the formation. Such interrogations are referred to as active seismic surveys.

Microseismic monitoring concerns passively monitoring a formation for seismic events which are very small. In passive monitoring, the formation is not interrogated, per se, but seismic receivers are placed to receive directly any seismic waves generated by events occurring within the formation. Such events may include the seismic effects generated in a formation by fracturing, depletion, flooding, treatment, fault movement, collapse, water breakthrough, compaction or other similar subterranean interventions or effects. This additional information about these events may be very useful in order to enhance the use of the formation or provide additional safety measures in certain situations. For example, it is common in the hydrocarbon production industry to fracture or “frac” a formation. During this operation, fluid and propant is pumped down a well at high pressure in order to generate additional fracturing within a zone of the well. The propant is pumped into these fractures and maintains them after the pressure is removed. Monitoring the seismic waves generated during and immediately after a frac operation can provide critical information about the operation, such as the direction and extent of the fractures being generated.

In yet another exemplary application, microseismic monitoring may be used to provide long-term monitoring for subterranean storage facilities and formations from which hydrocarbons or water is being produced. Under certain conditions, the integrity of these formations may become compromised, causing collapse. Such collapses may pose a safety concern for those on the surface, as entire sections of ground may fall into the collapse. However, often certain characteristic small seismic waves may precede such failures, permitting remedial measures to delay the collapse and ultimately warn of the impending collapse to allow for isolation of any dangerous areas from personnel.

Systems and methods are described for monitoring seismic events, and for determining the locations of seismic events. The systems and methods may provide for automatic location of those events. In some embodiments, seismic data may be analyzed as a set, with several receivers providing data for a joint analysis. Data is collected from a receiver and related to data collected from other receivers in order to derive additional information about the formation.

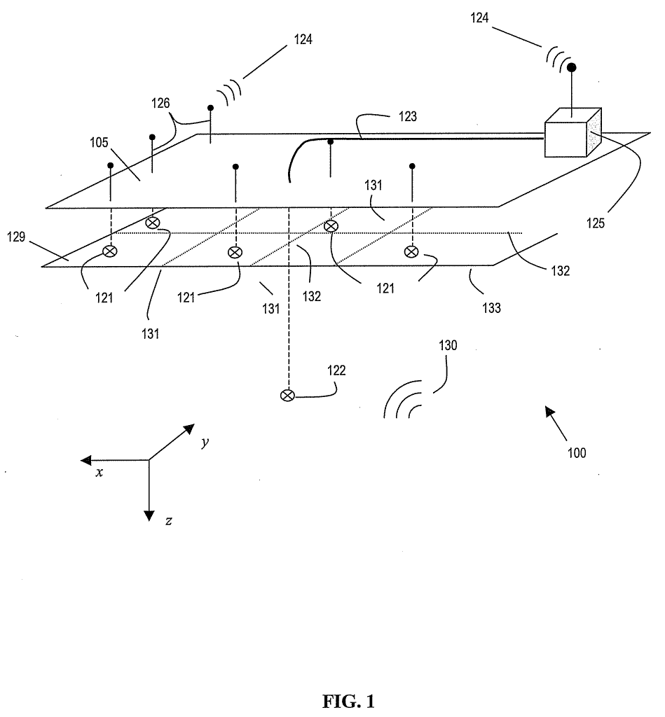

Referring to FIG. 1, in some embodiments, one or more subterranean formations are monitored using a network 100 of seismic receivers. The network 100 includes a plurality of seismic receivers 121 and 122, each of which are adapted for operation to receive seismic waves 130 generated by seismic activity and generate seismic trace data representing the waves 130 and indicative of the seismic activity. Each receiver 121, 122 may be a geophone (as shown in FIG. 1) and/or a hydrophone placed at a surface 105, and may be submerged in wells or on the ocean floor. Each receiver 121, 122 may be an analog or digital receiver. Other types of seismic receivers known now or in the future may also be used. Receivers 121, 122 may be placed in shallow wells (for example, above the formation of interest), deep wells (for example, at or below the formation of interest) or at the surface 105. The receivers 121, 122 may be sensitive to seismic waves along a certain axis or those traveling on any axis. Likewise, the receivers 121, 122 may be sensitive to only certain types of seismic waves, or several types. Those receivers 121, 122 sensitive to a certain axis of travel, called directional receivers, may be coupled with other directional receivers 121, 122. For example, multiple directional receivers 121, 122 may be coupled together in a set of three orthogonal receivers which collect information about the waves 130 in three dimensions. This three-dimensional information may be rotated mathematically through the use of trigonometric functions in order to derive information as to wave travel in the x-, y-, and z-axis relative to gravity. Alternatively, mathematical rotation may provide translation of the data relative to a wellbore, a cardinal direction, or any other reference point.

In one embodiment, the plurality of receivers 121, 122 includes a plurality of shallow well receivers 121. The plurality of receivers 121, 122 may optionally include one or more deep well receivers 122 (only one is shown in FIG. 1). The shallow well receivers 121 may be disposed at depths that are smaller than the depths at which the deep well receivers 122 are disposed. FIG. 1 shows the network 100 as including a plurality of shallow well receivers 121 and a single deep well receiver 122. However, any number of deep well receivers 122 or shallow well receivers 121 may be included in the network 100.

For illustration purposes, a virtual grid 129 is depicted in FIG. 1, and may be generated, for example by a collection machine 125 or other processor, to identify and define an area of interest. Such a virtual grid 129 may be provided for any number of receiver locations, and may include any combination of shallow well receivers 121 and deep well receivers 122 at various depths and locations. Although the grid 129 encompasses the locations of each receiver 121 in the embodiment shown in FIG. 1, one or more receivers 121 may be located outside of the grid 129.

In one embodiment, the receivers 121, 122 may be connected in communication with the collection machine 125 by a direct connection 123, such as a wired connection or a fiber connection, or by a wireless connection 124. In the embodiment shown in FIG. 1, the deep well receiver 122 is connected to the collection machine by a direct connection 123, such as a wired connection. The plurality of shallow well receivers 121 is connected to the collection machine 125 via a wireless connection 124. The wireless connection 124 may be provided for by an antenna 126 (and other suitable wireless equipment) for generation of a wireless communications signal. The illustration of FIG. 1 is non-limiting and merely exemplary of one embodiment of the microseismic network 100. For example, any number of shallow well receivers 121 and deep well receivers 122 may be included in the network 100. Furthermore, the collection machine 125 may be connected to the plurality of receivers 121, 122 by any combination of connections, included direct or wired connections and wireless connections.

The seismic waves of interest for microseismic monitoring are generally of very small amplitude. As small amounts of noise will affect the signal to noise ratio of the received signals greatly, it is advantageous to place the receivers 121, 122 in an area where noise is minimized. In one embodiment, the receivers 121, 122 should be placed as close to the source as possible. Such a placement maximizes the signal to noise ratio appreciated from the receiver. However, as the location of the sources is unknown at the onset, such a placement may not be feasible or possible. Additionally, the location of the sources of interest may generally be deep; placement nearby may be prohibitively costly, particularly for a large network. Though receivers 121, 122 may be placed at the surface 105 or undersea, one embodiment places the receivers beneath the weather layer. The weather layer is the geological layer under which the effects of climatological changes (wind, rain, temperature, humidity, etc.) are not detectable.

Each receiver 121, 122 is adapted to detect seismic signals, for example in the form of seismic or acoustic waves 130, and generate a stream of seismic trace data indicative of the waves 130. Trace data may include data regarding seismic events and data that is considered noise. Each stream of trace data includes a plurality of data points generated by a respective receiver 121, 122 during a selected duration of time or time window. The plurality of data points from a single receiver 121, 122 over the selected duration of time or time window is referred to as a “trace”. These data points may also be referred to as a “trace data stream”. In one embodiment, each of the plurality of data points represents an amplitude of the wave 130 received by the receiver 121, 122 at a certain time in the time window.

The network 100 used to detect the seismic signals may include any number of receivers 121, 122, and can be quite large. In one embodiment, each receiver location may record data from multiple receivers. For example, multiple receivers 121, 122 may be placed in a single location so that data may be recorded from multiple receivers 121, 122. Thus, the terms “receiver” and “receiver location” may analogously denote a location that may generate one or more traces. In another example, receivers 121, 122 that are sensitive to x-axis, y-axis, or z-axis directions may be disposed in a single location to record seismic events or activity. In such an example, three or more traces may be generated from each single location. Monitoring of an entire network, which may consist of tens or hundreds of sensing locations, may generate a large number of traces.

In one embodiment, the plurality of receivers 121, 122, or any subset thereof, are placed at substantially the same depth and/or are placed within a geology having a uniform velocity model. For example, as shown in FIG. 1, the shallow well receivers 121 are all placed at substantially the same depth. However, in an alternative embodiment, receivers 121, 122 having a variety of depths or within disparate velocity models may be used, with the data ultimately collected being corrected for such features. It will be understood that, though a “receiver” may be referred to in the singular, it may include one or more actual seismic sensors. For example, a receiver 121, 122 may include three component receivers.

In one embodiment, the receivers 121, 122 include permanent sensors, cemented in place in wells without casing. In alternate embodiments, however, the receivers 121, 122 may be placed within cased wells, placed at the surface 105 in a temporary manner or otherwise located by other methods known now or in the future.

The location of each receiver 121, 122 may be known and may be recorded in advance. In one embodiment, the locations of each receiver 121, 122 may form a grid, such as a grid of uniformly spaced receiver locations. In another embodiment, the locations may form a square grid, triangular grid or hexagonal grid. Any configuration of locations may be utilized, as desired by the user and/or based on the environment. Accordingly, any configuration of the set of receivers 121, 122 may be used. Information from multiple receivers 121, 122 (for example, three of the receivers 121) may be triangulated in order to estimate the location of a seismic event.

Each receiver 121, 122 may be equipped with transmission equipment to communicate ultimately to the collection machine 125 or other processing machine. Any of several different transmission media and methods may be used to connect any combination of receivers 121, 122 in communication with the collection machine 125. Examples of such connections may include wired, fiber optic or wireless connections. Other examples may also include direct, indirect or networked connections between the receivers 121, 122 and the collection machine 125.

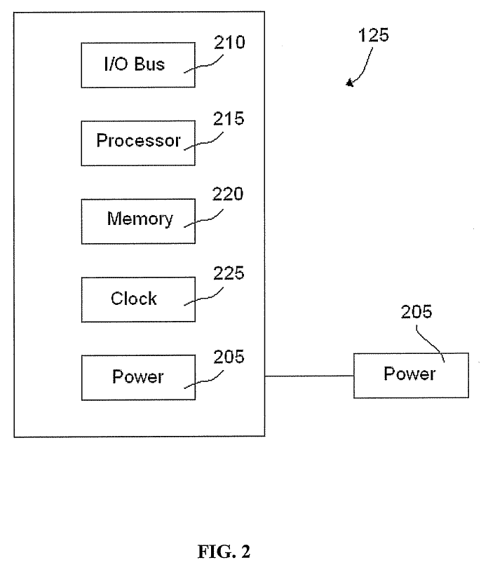

Referring to FIG. 2, the plurality of receivers 121, 122 may be connected to at least one collector, which may be a collection machine 125 or other device or system adapted to receive seismic traces from one or more of the plurality of receivers 121, 122. In one embodiment, the collector may include one or more collection machines 125 or other devices. The collector may be adapted to receive real-time or near real-time data.

The collection machine 125 may include a computer system having a storage medium. In one embodiment, the collection machine 125 may include, without limitation, at least one power supply 205, an input/output bus 210, a processor 215, a memory device or system 220, a clock 225 or other time measurement device, and other components (not shown) such as an input device and an output device. The power supply 205 may be incorporated in a housing along with other components of the collection machine 125, or may be connected remotely such as by a wired connection. Other components may be included as deemed suitable, such as additional processors and/or displays for providing and/or displaying seismic data.

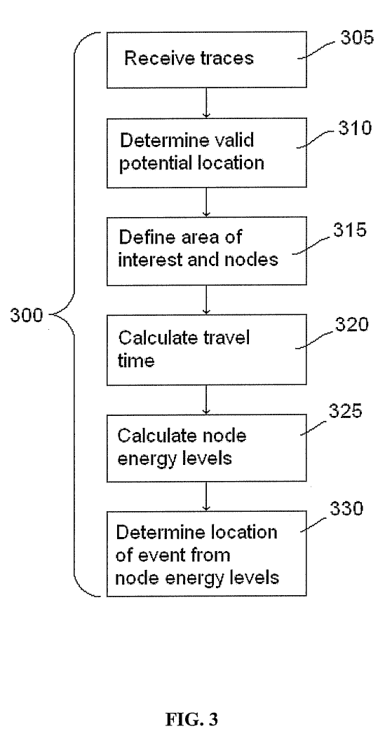

FIG. 3 illustrates a method 300 for monitoring seismic events and determining locations of seismic events, which may be utilized in, but is not limited to, microseismic passive monitoring. The method 300 includes one or more stages 305, 310, 315, 320, 325 and 330. The method 300 is described herein in conjunction with the plurality of receivers 121, 122, although the method may be performed in conjunction with any number and configuration of receivers. The method 300 may be performed by the collection machine 125 and/or any other processor, which may be associated with the collection machine 125 and/or one or more of the plurality of receivers 121, 122.

In a first stage 305, traces are received from one or more of the plurality of receivers 121, 122. In one embodiment, each trace is collected by the collection machine 125. For example, the collection machine 125 collects traces from at least three receivers 121. The traces collected from the receivers may include real-time or near real-time data.

In one embodiment, the method 300 may be performed in response to receiving seismic data by the collection machine 125 or other processor. For example, the collection machine 125 may be adapted to automatically initiate the method 300 in response to a triggering event. An example of a triggering event may include the reception of a seismic signal having a magnitude greater than a selected threshold magnitude. The collection machine 125 may automatically process the seismic data in real-time or near real-time, such as by the method 300. The collection machine (or other processor) may thus provide real-time or near real-time location information as a seismic event is occurring.

In a second stage 310, the traces are processed, for example by the collection machine 125, for a potential event location to determine if a valid potential event occurred at that location.

In one embodiment, a wavelet transform may be provided to validate the potential event by recognizing an actual seismic event. A mother wavelet may be provided that has been extracted from a seismic signal recorded at the receiver location that corresponds to a known actual seismic or microseismic event. Wavelet processing allows the system to identify and/or classify seismic events.

Use of the wavelet transform allows for the discarding of signals that exceed the selected threshold magnitude, but otherwise are not indicative of seismic events. For example, noise generated by human surface activity or other sources may generate signals that exceed the selected threshold magnitude and thus may trigger the method 300. Initiation of the method 300 solely based on the threshold may not be sensitive to different types of signals that exceed the threshold, as initiation may be triggered as soon as the signal is energetic enough. Processing to validate the traces (e.g., based on the wavelet transform) allows for the discarding of traces representing known sources of noise, and thus reduces the risk of false alarm.

In one embodiment, the processing may include processing data from multiple receivers in relation to a potential event location to determine whether the potential location is valid. For example, if an intermediate receiver between the potential event location and a subject receiver did not detect an event, then there was no event at the potential event location. Either the event occurred at a different location or the event is the result of an error in the system.

If the potential event appears valid and for a valid location within the field of interest, the collection machine 125 begins a beam forming process to automatically locate the location of the event. The process is based upon the calculation of an energy level after a time-shift of the traces at one or more receivers and a summation of the resulting traces.

The following naming and numbering convention is provided to illustrate the method 300 described herein. The naming and number convention provided is arbitrarily chosen, and is provided for explanation only.

“Rn” corresponds to a specific receiver number in the plurality of receivers, at a given location at the surface or downhole in a wellbore, such as wellbore 125. For example, each of the receivers 121 may correspond to R1, R2, R3 . . . Rn, respectively. “Traceₘ(t)” corresponds to each of a plurality of data points in a specific trace in a specific time window. “E_{Rn}(t)” corresponds to a trace generated by a receiver having a corresponding receiver number, which may be computed from multiple traces (traceₘ(t)). In one embodiment, traceₘ(t) and E_{Rn}(t) represent the amplitude or energy level of a waveform for each of the plurality of data points in the time window. “F_{Rn}(t)” corresponds to a time-shifted trace. “Nodeₓ” corresponds to each of the plurality of nodes, such as nodes 131. “Eₓ(t) corresponds to a node trace, and “Eₓ” corresponds to a node energy value for each nodeₓ.

In a third stage 315, an area of interest is defined, which may include an area around one or more of the plurality of receivers 121 that detected the event. The area of interest is divided into an array of nodes. Each node may represent a probability location, i.e., a probability that a seismic event has occurred at the location of the node. In one embodiment, as shown in FIG. 1, the area of interest is defined by the grid 129. The grid 129 may be bounded by boundary lines 133 and further divided by grid lines 132. In this embodiment, nodes 131 are formed by the intersections between the boundary lines 133, intersections between the grid lines 132, and/or intersections between the grid lines 132 and the boundary lines 133.

In a fourth stage 320, a travel time from each receiver 121 to the nodeₓ is computed with reference to the geologic model. Calculation of travel time may, for example, be computed using a pre-determined signal velocity based on a geologic model and distances between the nodeₓ and each receiver 121.

In one embodiment, calculation of travel time assumes a uniform geologic model, but does not require such uniformity. If the geologic model is non-uniform, the non-uniformity may be taken into account as the different geologic models are computed in the travel time calculation. In another embodiment, the receivers 121 are initially placed in a configuration that permits uniform geologic model treatment. Similarly, the receivers 121 may be initially placed in a configuration that may improve or optimize the method 300 by taking into account the non-uniformity of the model. Such a placement may be provided, for example, in order to obtain a similar waveform on the different receivers 121 for a particular target zone and/or in order to improve the location accuracy.

In a fifth stage 325, each of the traces for the receivers 121 is adjusted for each of the array of nodes according to the travel time. In one embodiment, each of the traces (traceₘ(t)) or (E_{Rn}(t)) for the receivers 121 used in conjunction with the nodeₓ location is time-shifted to match the travel time to the nodeₓ. A time-shifted trace (F_{Rn}(t)) may be calculated for each receiver 121.

The traces (traceₘ(t)) may be processed to produce a single trace (E_{Rn}(t)) for a location of each receiver 121. In the event that a receiver location includes multiple receivers or sensors, the traces (traceₘ(t)) from each receiver or sensor may be summed together to form the single resultant trace (E_{Rn}(t)). The trace (traceₘ(t)) may be a single trace or multiple traces from a single receiver location. In one embodiment, for a receiver location that generates only one trace, the trace (traceₘ(t)) may be equivalent to the resultant trace (E_{Rn}(t)).

For example, the trace (traceₘ(t)) may either be the trace of one particular axis of the receiver or traces corresponding to multiple axes, such as orthogonal x, y and z axes. In one embodiment, three-dimensional information from a respective receiver 121 may be mathematically rotated in the direction of the nodeₓ and the trace (traceₘ(t)) corresponding to the longitudinal direction between the respective receiver and the nodeₓ may be selected as the “trace” for the respective receiver.

In one embodiment, the resultant trace (E_{Rn}(t)) may be calculated using the following equation (Equation 1):

E_{Rn}(t)=sqrt [trace₁(t)²+ . . . traceₘ(t)²]. (1)

### In this embodiment, the resultant trace (E_{Rn}(t)) for each receiver 121 is calculated by calculating a square root of the sum of the square of each traceₘ(t) received for a respective receiver 121 in a selected time window.

In one example, the resultant trace (E_{Rn}(t)) is calculated from the traces (traceₘ(t)) generated by a multi-dimensional receiver, such as a receiver 121 that generates traces in three orthogonal dimensions x, y and z. These traces may be represented as traceₓ(t), trace_{y}(t) and trace_{z}(t). Calculation of the resultant trace (E_{Rn}(t)) may be represented by the equation (Equation 2):

E_{Rn}(t)=sqrt [traceₓ(t)²+trace_{y}(t)²+trace_{z}(t)²]. (2)

### In this equation, traceₘ(t) is the trace of a first horizontal axis, trace_{y}(t) is the trace of a second horizontal axis, and trace_{z}(t) is the trace of a vertical axis.

In one embodiment, each traceₘ(t) and/or resultant trace (E_{Rn}(t)) may be calculated using methods that include statistical analysis, data fitting, and data modeling. Examples of statistical analysis include calculation of a summation, an average, a variance, a standard deviation, t-distribution, a confidence interval, and others. Examples of data fitting include various regression methods, such as linear regression, least squares, segmented regression, hierarchal linear modeling, and others. Examples of data modeling include direct seismic modeling, indirect seismic modeling, and others.

In one embodiment, the time-shifted traces (F_{Rn}(t)) from the receivers 121 are summed or stacked to determine a node trace (Eₓ(t)) corresponding to the nodeₓ.

The node trace (Eₓ(t)) may be calculated from any number of time-shifted traces (F_{Rn}(t)). Such a calculation may be represented by the equation (Equation 3):

Eₓ(t)=[F_{R1}(t)+ . . . F_{Rn}(t)] (3)

This equation represents a sum of the time-shifted traces (F_{Rn}(t)) from a plurality of receivers (Rn). The plurality includes a first time-shifted trace from a first receiver, represented by “F_{R1}(t)”, and additional time-shifted trace(s) from any number of additional receivers, represented by “F_{Rn}(t)”. The number of additional time-shifted traces (F_{Rn}(t)) is potentially infinite and limited only by the ability to process and present reliable data. In one embodiment, only the traces which have been selected by the wavelet process as really containing a signal related to a seismic event are used for the calculation of the node trace.

A node energy level (Eₓ) for nodeₓ may then be calculated from the time-shifted traces (E_{Rn}(t)). In one embodiment, the node energy level (Eₓ) is calculated based on the node trace (Eₓ(t)) and/or the time-shifted traces (F_{Rn}(t)).

The node energy level (Eₓ) may be calculated, for example, by normalizing the values of the time-shifted traces (F_{Rn}(t)) to achieve a scale value, such as a scale value having a maximum of one (1). Normalization may be achieved by a method including, for example, division of the time-shifted traces (F_{Rn}(t)) by the standard deviation.

In one embodiment, the node energy level (Eₓ) may be calculated using the equation (Equation 4):

(Eₓ)=∫Eₓ(t)²dt (4)

In this equation, the boundary of the integral corresponds to the boundaries of a selected time window. This equation may represent an energy level corresponding to the nodeₓ.

In another embodiment, the node energy level (Eₓ) may be calculated using the equation (Equation 5):

(Eₓ)=(1/N)*∫Eₓ(t)²dt/[∫F_{R1}(t)² dt+ . . . ∫F_{Rn}(t)²dt] (5)

### In this equation, N represents the number of receivers 121 or receiver locations used with the respective nodeₓ. The boundary of the integrals in this equation correspond to the boundaries of a selected time window.

The above Equations 4 and 5 yield equivalent values in terms of probability, however the value yielded by Equation 5 is normalized and may have a value between zero (0) and one (1). Higher values, including values that are close to and approaching one (1), may indicate seismically active zones (e.g., zones that emit a lot of noise) and/or seismic events and may be an indicator of the consistency of the signal on the different receivers 121 used for calculating the node trace Eₓ(t). In one embodiment, these values can be related to a quality parameter (or confidence parameter) of the location.

The method for calculating the node energy level (Eₓ) is not limited. The node energy level (Eₓ) may be calculated by determining the energy level of the stacked node trace (Eₓ(t)) by any other suitable methods known now or in the future.

Stages 320 and 325 define an iterative process that is undertaken for each node. Thus, stages 320 and 325 are repeated for each nodeₓ, so that each node may be assigned an energy level (Eₓ).

In a sixth stage 330, the node energy levels (Eₓ) are compared, and the node with the greatest node energy level (Eₓ) is estimated to be the location of the event. In one embodiment, in the case that the event actually occurs outside of the field of interest, the greatest node energy level (Eₓ) may be located on the edge of the field of interest. In such a case, the result (i.e., the greatest node energy level (Eₓ)) is tested to see if the estimated location, i.e., nodeₓ having the greatest energy level (Eₓ), is on the edge of the field of interest. If so, the result is discarded and a different field of interest may be selected in order to properly estimate the location of the event.

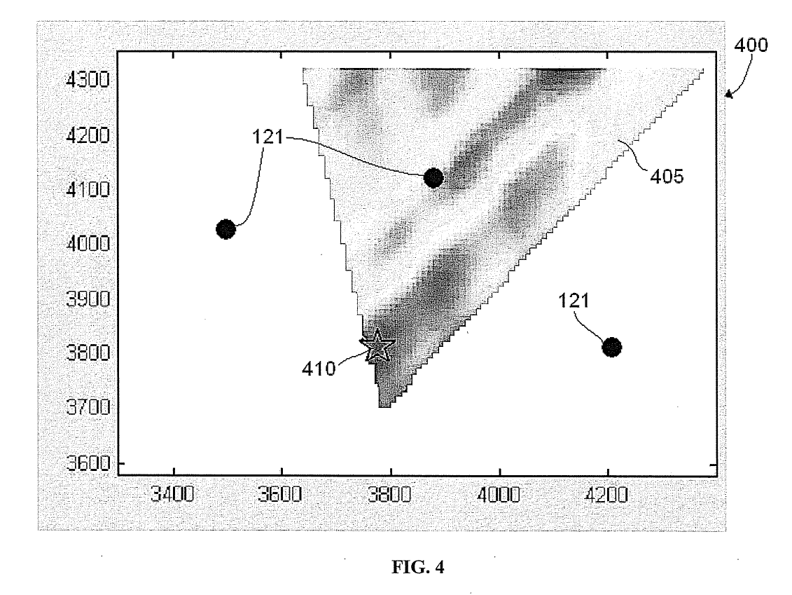

Referring to FIG. 4, in one embodiment, the results of the node energy level (Eₓ) computation for each nodeₓ may be plotted on a graph at a representative location relative to the receivers 121. Values of Eₓ may be represented by varying shades and/or colors. For example, FIG. 4 shows a plot 400 of Eₓ values for a plurality of nodes, in relation to the receivers 121. In the current example, greater values of Eₓ are shown as darker areas in an area of interest 405. In another example, greater values of Eₓ may be represented by one color (red, for example), with lesser values represented by another color (blue, for example). In this way the results of the automatic location may be quickly appreciated by the system user. The location of the receivers 121 may be represented on the plot 400 (in the current example, by a circle), as well as the location 410 of greatest energy (in the current example, by a star).

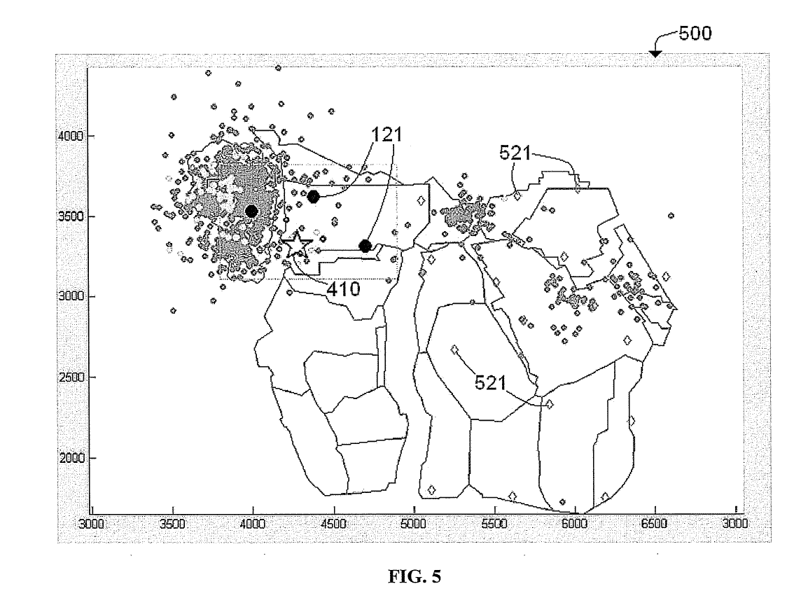

The result of the automatic location process may then additionally be plotted on a wider map 500 of the field being monitored, as shown for example in FIG. 5. The locations of receivers 121 used in the method described herein (and shown in FIG. 4) are provided, in addition to the locations of additional receivers 521 on the map 500.

In one embodiment, the system assumes a fixed depth for all receivers. For example, all of the receivers in the network 100 are shallow well receivers 121. However, non-fixed depth networks of receivers may be used, and the depth may be corrected according to known means. Accordingly, a deep well receiver 122 is depicted to also illustrate aspects of other networks 100.

In one embodiment, if at least three receiver locations are used in the method described herein, the location of the event may be computed within two dimensions. If at least four receiver locations are used and a three-dimensional area of interest is selected, the location of the event may be estimated in three dimensions.

In one embodiment, the method described herein is performed in real-time or near real-time, so as to immediately (for example, within approximately 60 seconds) provide information as to the location of events. “Real-time” data may refer to data transmitted to the collection machine upon or shortly after detection and/or recordation by one or more receivers 121, 122. In this embodiment, the results may be achieved quickly enough to modify a frac process, remove personnel from a dangerous area, or allow other interventions in time to save life, limb and property.

In one embodiment, the location identified by the foregoing method is considered the most probable point at which an event has occurred. In one embodiment, the second-most-probable and other less likely locations are also recorded, along with their energy strengths. The results of several automatic location processes may then be summed in order to select a location having an improved probability of being the location of the event. In another embodiment, the less-likely locations are simply reported to the user as secondarily probable locations of the event.

Additionally, at least one program storage device readable by a machine, tangibly embodying at least one program of instructions executable by the machine to perform the method 300 may be provided. In one embodiment, the method 300 is performed by a processor or other processing machine such as collection machine 125.

The systems and methods described herein provide various advantages over existing seismic monitoring systems. The systems and methods described herein allow for accurate determination of seismic event locations, and also provide seismic event location information in a very timely manner, so that interventions may be undertaken immediately as suggested by the events.

In support of the teachings herein, various analysis components may be used, including digital and/or analog systems. The devices, systems and methods described herein may be implemented in software, firmware, hardware or any combination thereof. The devices may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the devices and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure. The computer executable instructions may be included as part of a computer system or provided separately.

Further, various other components may be included and called upon for providing for aspects of the teachings herein. For example, a pump, piston, power supply (e.g., at least one of a generator, a remote supply and a battery), motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for locating a seismic event, the method comprising:
processing seismic data from at least one seismic receiver to validate a potential seismic event;
computing a signal travel time between at least one node in an area of interest and the at least one seismic receiver;
adjusting the seismic data according to the signal travel time; and
identifying a location of the seismic event based on the adjusted seismic data.

2. The method of claim 1, wherein the seismic data is real-time seismic data.

3. The method of claim 1, wherein processing comprises performing wavelet processing on the seismic data.

4. The method of claim 1, wherein the signal travel time is computed based on a velocity of a signal and a distance between the at least one seismic receiver and the at least one node.

5. The method of claim 1, wherein adjusting the seismic data comprises time-shifting the seismic data to match the signal travel time.

6. The method of claim 1, wherein processing occurs in response to receipt of the seismic data.

7. The method of claim 1, further comprising:
receiving at least one trace (traceₘ(t)) from the seismic data within a time window; and
computing a resultant trace (E_{Rn}(t)) using the equation:
E_{Rn}(t)=sqrt [trace₁(t)²+ . . . traceₘ(t)²],
“trace₁(t) . . . traceₘ(t)” representing one or more traces (traceₘ(t)) received from the at least one seismic receiver within the time window.

8. The method of claim 1, further comprising computing a trace (F_{Rn}(t)) of the adjusted seismic data.

9. The method of claim 8, further comprising computing a node trace (Eₓ(t)) based on the trace (F_{Rn}(t)).

10. The method of claim 9, wherein computing the node trace (Eₓ(t)) comprises using the equation:
Eₓ(t)=[F_{R1}(t)+ . . . F_{Rn}(t)]
“F_{R1}(t) . . . F_{Rn}(t)” representing the trace (F_{Rn}(t)) of the adjusted seismic data for each of the at least one receiver.

11. The method of claim 9, further comprising computing a node energy level (Eₓ) based on the node trace (Eₓ(t)).

12. The method of claim 11, wherein computing the node energy level (Eₓ) comprises using the equation:
Eₓ=∫Eₓ(t)²dt.

13. The method of claim 11, wherein computing the node energy level (Eₓ) comprises using the equation:
Eₓ=(1/N)*∫Eₓ(t)dt/[∫F_{R1}(t)dt+ . . . ∫F_{Rn}(t)dt],
“N” representing a number of the at least one receiver, and “F_{R1}(t) . . . F_{Rn}(t)” representing the trace (F_{Rn}(t)) of the adjusted seismic data for each of the at least one receiver.

14. The method of claim 11, further comprising computing at least another node energy level (Eₓ) for at least another node, comparing the node energy level (Eₓ) of the at least one node and the at least another node, and determining the location of the seismic event based on a greatest node energy level (Eₓ).

15. The method of claim 11, further comprising graphically presenting a location and node energy level (Eₓ) of the at least one node.

16. A system for locating a seismic event, the system comprising:
a collector providing seismic data from a plurality of seismic receivers to a processor for processing the data signals,
wherein processing comprises processing the seismic data to validate a potential seismic event, adjusting the seismic data from at least one of the plurality of seismic receivers according to a signal travel time between at least one node in an area of interest and the at least one of the plurality of seismic receivers, and identifying a location of a seismic event based on the adjusted seismic data.

17. The system of claim 16, wherein the plurality of seismic receivers comprises locations selected from at least one of: a surface and within a well.

18. The system of claim 16, wherein each of the plurality of seismic receivers are located at substantially equal depths within a geology.

19. The system of claim 16, wherein the processing further comprises:
receiving the seismic data from the plurality of seismic receivers;
defining the at least one node in the area of interest; and
computing the signal travel time for the at least one node.

20. A system for locating a seismic event, the system comprising:
a collector for receiving seismic data from a plurality of seismic receivers and providing the seismic data to a processor,
wherein the processor implements a method comprising:
processing the seismic data to validate a potential seismic event; defining an area of interest; defining at least one node in the area of interest; computing a signal travel time between the at least one node and at least one of the plurality of seismic receivers; adjusting the seismic data for the at least one node according to the travel time; and identifying a location of the seismic event based on the adjusted seismic data.
